(19) United States
(12) Patent Application Publication
(10) Pub. No.: US 2003/0012701 A1
(43) Pub. Date: Jan. 16, 2003

(54) Insulated specimen sampling and shipping kit

(76) Inventors: Jangbir S. Sangha, Overland Park, KS (US); Steve Hammond, Olathe, KS (US)

Correspondence Address: SPENCER, FANE, BRITT & BROWNE, 1000 WALNUT STREET, SUITE 1400, KANSAS CITY, MO, 64106-2140, US

(21) Appl. No.: 09/904,643

(22) Filed: Jul. 13, 2001

(51) Int. Cl. G01N 1/00

(52) U.S. Cl. 422/102; 604/317; 422/61; 62/457.2

(57) ABSTRACT

A blood specimen sampling and insulated shipping kit is provided that provides a user with all materials that are needed to initiate blood flow, direct a blood sample into a sample vial, insulate the vial from heat and cold, protect the vial from impact, and ship the blood sample containing vial to a clinical laboratory for testing.

### FIELD OF THE INVENTION

The present invention relates to the field of biological fluid sampling and shipping. In particular, the present invention provides a complete kit to allow a user to obtain a blood sample from themselves, to capture the blood sample within a sealed vial and to ship the blood sample to a clinical testing laboratory in a properly insulated package meeting all regulations for shipment of biological samples.

### BACKGROUND OF THE INVENTION

In the 1980's, it became beneficial for insurance companies to request that individuals desiring health insurance or life insurance policies undergo some degree of clinical laboratory testing in order to determine if the individual seeking insurance has any pre-existing conditions which would militate against offering a policy of insurance for the individual or indicate that higher premiums were in order. Two conditions which were initially of great interest to insurance companies were the determination of the existence or risk of diabetes, liver disease, or cardiovascular disease, and the determination of whether or not the individual seeking life insurance was a tobacco user. In recent years the use of such clinical laboratory testing has expanded to include testing for various drugs and other disease states. Another application of risk assessment testing, which employs clinical laboratory techniques, is in the area of monitoring diabetes, cardiovascular disease, or other chronic diseases. Plasma or serum lipid analysis including testing for cholesterol (C), high density Lipoprotein Cholesterol (HDL-c), low density Lipoprotein Cholesterol (LDL-c), and triglycerides (Trigs) helps in assessing the cardiovascular status of a subject.

In utilizing clinical laboratories to conduct periodic patient monitoring of health conditions, it is necessary to acquire blood samples from the patients. Automated or semi-automated autoanalyzer procedures for lipids and other analytes use blood plasma or serum matrix samples. The standard method of blood collection from a subject involves a health care professional, associated with a laboratory, hospital, or a collection center. Venous blood is drawn into an evacuated tube which may or may not, depending on the requirements, contain a pre-determined amount of an anticoagulant or a clot enhancer. After the venous blood specimen is collected, the whole blood is centrifuged to separate the plasma or serum from the cellular components. Separated plasma or serum is sent to the laboratory for testing for analytes of interest.

The most efficient way of obtaining liquid blood samples is to avoid having the patient report to a physician's office or laboratory specimen sampling location, and to have the patient learn to self-draw a small blood sample which can be transported to the clinical laboratory for testing. In the past, methods have been developed for off-site collection of blood samples from patients. One such example is the dried blood spot method of blood collection. In the dried blood spot method, the patient's finger is pricked with a lance and droplets of blood are placed onto a specified area of an absorbent paper. The absorbent paper is then allowed to dry, and the paper is then sent to the clinical laboratory test location.

A major drawback of the dried blood spot method is that it can be difficult for the inexperienced user to properly fill the absorbent paper with sufficient blood. Since the filter paper should be completely filled with blood in the area designated and saturated from front to back of the paper, substantial room for error exists when a dried blood spot collection is self-administered by an inexperienced individual. In addition, the dried blood spot method can become contaminated if the filter paper is placed on a contaminated surface. Such contamination can render the blood sample unusable by the time the specimen reaches the testing laboratory. Another drawback of dried blood spot technology is the need to properly dry the sample prior to shipping it. If the inexperienced user does not properly dry the sample, it is possible for microorganisms to begin growth on the wet blood spot sample.

Yet another drawback of the dried blood spot method of sampling is that the sample is in a dry state. Dried blood specimens require customized reagents and procedures for analysis, which include separating the blood specimen from paper and converting it to a liquid matrix for testing. Currently, there are no Food and Drug Administration approved methods for lipid analysis using dried blood samples.

Certain laboratory tests can be more efficiently performed if a liquid sample is received by the clinical testing laboratory. However, since liquid blood samples require additional protective packaging to prevent breakage of the specimen container, and as liquid samples must be protected from overheating or freezing during shipment, liquid forms of user-collected, or self-collected, specimens have presented hurdles to convenient use. Further, providing a user with a complete range of the equipment needed to obtain a liquid blood sample and to properly package the liquid blood sample for shipment has, in the past, represented a substantial barrier to wide-spread use of self-collected liquid blood samples for clinical laboratory testing.

It would make sense if the efficiencies of systems above were combined to make sample collection and testing simple. One way to do it is to enable the subject to collect a whole blood specimen from a finger-stick at home or at his/her convenience into a minitube and send the collected specimen in an appropriately designed mailing container to a laboratory for analysis. The laboratory receives the whole blood sample in good condition and analyzes the serum or plasma from the specimen with routine serum or plasma procedures.

The present invention overcomes these limitations by providing a user a single convenient package which contains all necessary implements for piercing a finger and obtaining a blood sample and collecting the blood sample in an appropriate shipping vial and providing all necessary packaging and materials for shipping the blood sample in a properly insulated package to the clinical testing laboratory.

The present invention also provides the benefits of providing a means for accomplishing general health screening of subjects by use of conventional liquid blood protocols while avoiding the need for the subject to travel to an physician's office or clinical laboratory for sample collection.

The present invention allows general health screening by use of conventional liquid blood protocols of subjects who may be in distant rural locations while avoiding the need for the subject to travel to an physician's office or clinical laboratory for sample collection.

The present invention also offers the cost saving advantage of permitting the use of conventional liquid blood protocols while allowing subjects to ship or mail a self-obtained liquid blood to a clinical testing laboratory without the need to travel to a physician's office or clinical laboratory for sample collection.

Another advantage of the insulation material of the present invention is that it uses non-refrigerated or frozen materials, thereby eliminating the need for bulky pre-cooling or pre-freezing the protective materials which require the additional preparation steps of cooling or freezing by the user to effect their operation.

Yet, another advantage of the specimen collection kit of present invention is small enough to fit in an ordinary mailbox and therefore is cost effective. This is a major advantage of the present invention in combination with the inventive insulation material over the prior art. The prior art shipping materials rely upon pre-cooled or pre-frozen polyethylene and glycol brick which maintains the specimen at an acceptable temperature range. These polyethylene and glycol bricks are, generally, 2 inches by 4 inches by 4 inches. The bricks are placed into a protective package with specimen. This results in a shipping package which is very often too large to fit into a standard U.S. Postal Service approved mailbox. The present invention, having a compact size, is able to fit into a standard U.S. Postal Service approved mailbox and thereby avoid the need to take the package to the post office or the need to use another, less convenient, package shipper.

Another advantage of the present invention is that it provides temperature protection in all seasons—both cold weather and hot weather. The inventive insulation of the present invention maintains the specimen within a safe temperature range by preventing the temperature of the outside-of-package weather from raising or lowering the specimen temperature to a point that would damage the specimen. In general, the insulation of the present invention maintains the specimen at a temperature of approximately 40 degrees centigrade and above approximately freezing.

### SUMMARY OF THE INVENTION

The present invention provides a user, within a single kit of materials, all apparatus needed to lance a finger to start blood flow, to capture the liquid blood within a container having a preservative, to properly package and insulate the blood sample and to ship the blood sample to a clinical laboratory for testing. The present invention further provides a lightweight and compact insulating material for protecting a liquid biological sample from extremes of heat and from freezing for a sufficient period of time to accomplish shipping of the liquid biological material from a user to a clinical laboratory testing location.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front and top perspective view of the specimens, sampling and shipping kit of the present invention and showing the various components of the kit;

FIG. 2 is a top front perspective view of the protective tube containing the specimen vial and the specimen vial stand in position to receive the tube;

FIG. 3 shows the tube inserted into the specimen stand and the hand of a subject allowing droplets of blood to fall into the funnel which has been inserted into the specimen vial;

FIG. 4 is a top front perspective view of the user information card;

FIG. 5 is a top front elevational view of the labeled protective tube being placed into the vial bag in preparation for shipment of the vial to the testing laboratory;

FIG. 6 shows the insulative pouch unit in its unfolded or flat position with directional arrows indicating the method of folding the insulative pouch unit for insertion into the insulative holder;

FIG. 7 shows the folded insulative pouch unit in position for insertion into the insulative holder;

FIG. 8 shows the insulative pouch partially inserted into the insulative holder;

FIG. 9 shows the specimen vial within the vial bag, both of which have been inserted into the specimen case containing the insulating pouch unit within the insulative holder;

FIG. 10 shows, schematically, the successive layering of the insulation of the present invention;

FIG. 11 is a cross-sectional view taken along a line 11-11 of FIG. 12 showing the manner of capture of the vial bag containing the specimen vial within the arms of L-shaped insulative sleeves contained within the specimen case and showing the case hinge in position on the specimen case to hold the case top and bottom in hinged association; and

FIG. 12 shows the specimen case being inserted into the case securing sleeve.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted a limiting, but merely as a basis for the claims and as a representative basis for teaching one skilled in the art to variously employ the present invention in virtually any appropriately detailed structure.

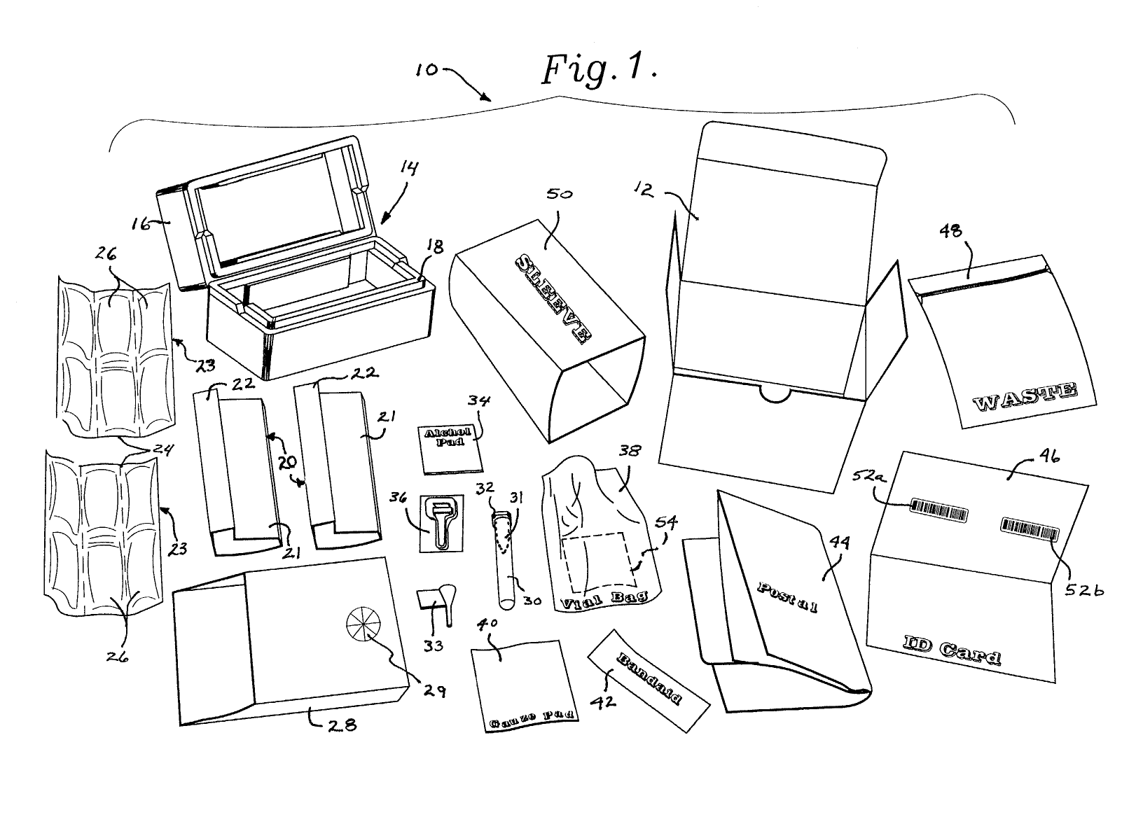

Referring now to FIG. 1, the components of insulated specimen sampling and shipping kit 10 of the present invention are shown. Specimen sampling and shipping kit 10 is comprised of: shipping box 12; specimen case 14 which includes case top 16 and case bottom 18; insulative holder 20 having holder body 21 and holder arm 22; insulating pouch 23; specimen vial stand 28 having opening 29; protective tube 30 containing microspecimen vial 31; funnel 33; alcohol pad 34, lance 36; vial bag 38; gauze pad 40; bandage 42; mailing envelope 44; information card 46; waste bag 48, securing sleeve 50, bar code labels 52a and 52b, and absorbent 54. The function and interrelationship of each of the components comprising the specimen sampling and shipping kit 10 will be described in detail hereinafter.

In general, the insulated specimen sampling and shipping kit 10 permits shipping of a single package to a user which will allow the user to obtain properly a blood sample from themselves without any additional help or instruction beyond that which accompanies kit 10. The user receiving kit 10 is able to perform the entire procedure of preparing their finger for drawing of a specimen, lancing the finger to start the flow of blood, introducing the blood sample into a specimen vial, sealing the vial specimen in a moisture-proof bag, packing the vial and bag in an insulated container to maintain the sample within a safe temperature range, and to mailing the insulated specimen, according to applicable postal regulations, back to the clinical testing laboratory. All this is be accomplished through the use of the present invention and the components comprising the kit.

The process of using the specimen sampling and shipping kit 10 will now be described. A typical user of kit 10 is a candidate for life or health insurance or a patient under the care of a physician. The candidate for insurance needs to present a blood sample to be considered for insurance. The patient often needs to present a periodic specimen, in this case, a blood specimen, for monitoring of their health status. Such users of kit 10 will receive kit 10 either through the mail or by hand delivery. Upon receiving kit 10, the user is equipped with all that is needed to obtain a blood sample and to submit the obtained blood sample in an insulated condition to a clinical testing laboratory for analysis. All the materials of kit 10 are supplied to the user within shipping box 12. Specifically, each of the items identified in FIG. 1, at least, are contained within shipping box 12 so the user has all that is needed to obtain the blood specimen and return it to the clinical laboratory.

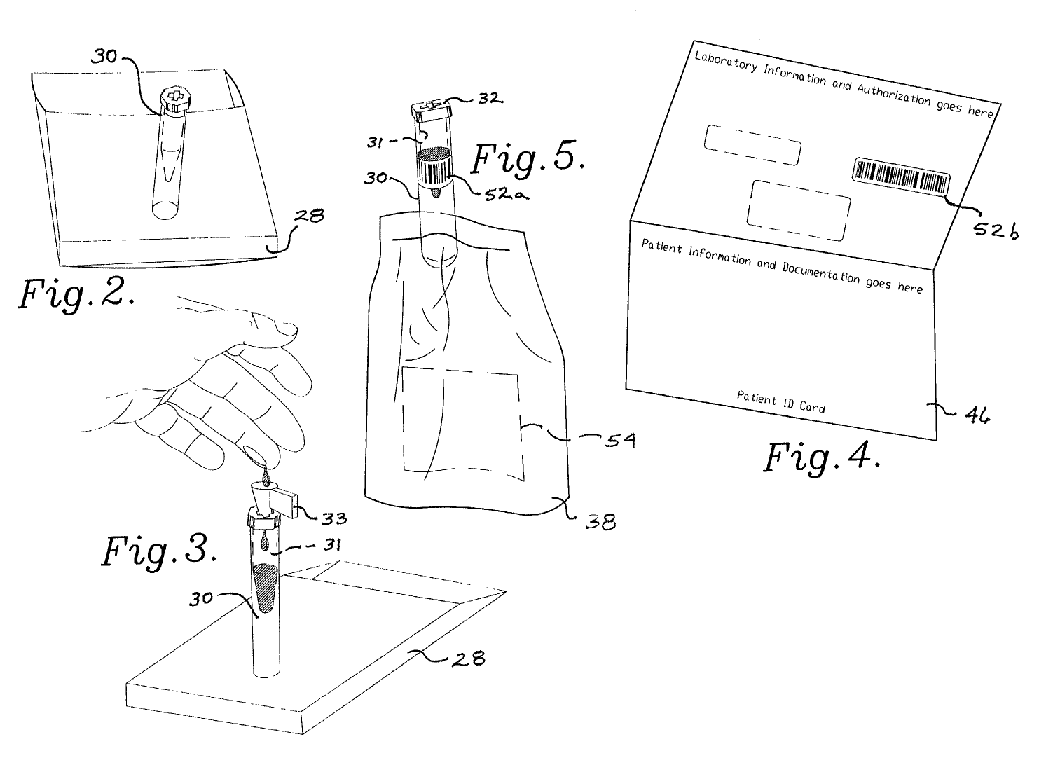

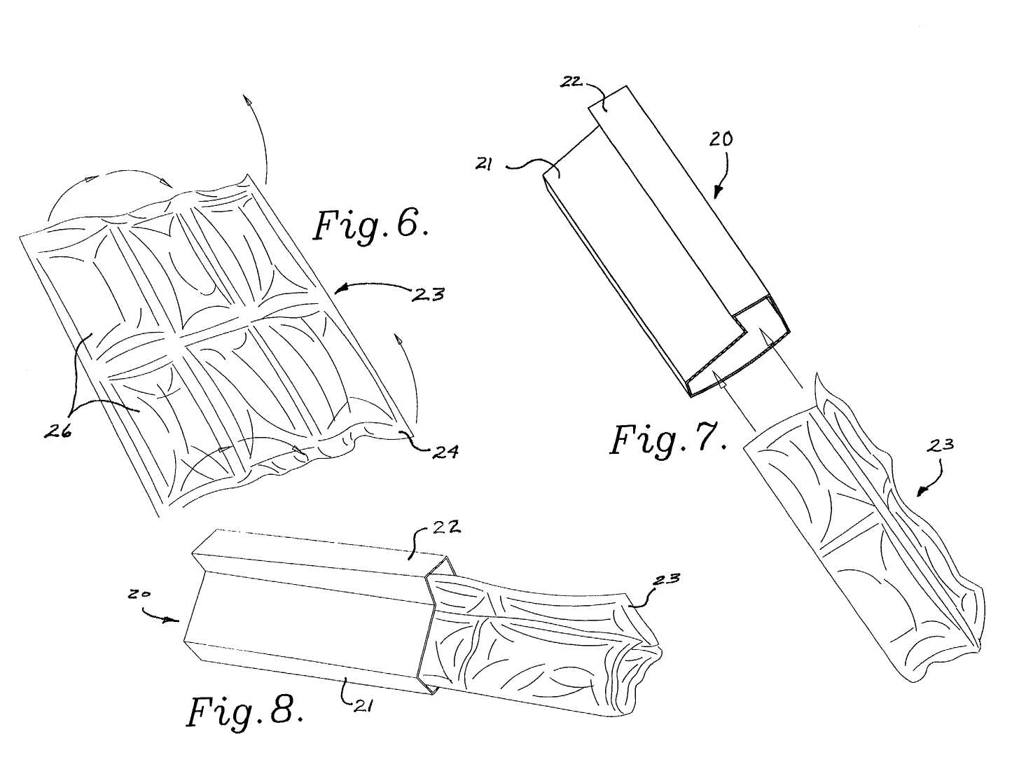

Still referring to FIG. 1, in operation, the user of kit 10 will locate specimen sample protective tube 30 which is a plastic tube having microspecimen vial 31 contained within the glass vial. Microspecimen vial 31 is marked at a level to indicate approximately one milliliter of fluid sample and is provided with a conditioning solution of Ethylenediaminetetraacetic acid EDTA to preserve the blood sample once it is placed within microspecimen vial 31. To fill microspecimen vial 31, tube 30 is inserted into opening 29 of specimen vial stand 28 so that vial 31 is held in an upright position for receiving the fluid blood sample (FIG. 2.). When tube 30 containing vial 31 has been secured in vial stand 28, the user will select funnel 33 from the contents of kit 10 (FIG. 1), and the user will insert funnel 33 through vial cap 32 (FIG. 3). Once tube 30 is placed in an upright position in vial stand 28, and funnel 33 is inserted through vial cap 30, the specimen vial is ready to receive a blood sample from the user.

Blood flow is initiated by use of lance 36 contained within kit 10. Lance 36 is a small blade of approximately two millimeters in width which is contained within a plastic holder. The user selects a finger of the hand, cleans the fingertip with alcohol pad 34 of kit 10, holds lance 36 against the fingertip area and depresses, firmly, the plunger of lance 36. The user's pressure against lance 36 causes sudden release of the lance from its holder which jabs the fingertip sufficiently to initiate blood flow from the created wound. As shown in FIG. 3, the blood from the fingertip is then permitted to drip through funnel 33 and into specimen vial 31. After sufficient blood has been placed into specimen vial 31, the user covers the wound on the finger with bandage 42 of kit 10. The user then removes funnel 33 from specimen vial cap 32 and places the used funnel into the waste collection bag 48 of kit 10. The user removes protective tube 30 specimen vial 31 from vial stand 28 and rotates the collection tube slowly to mix the blood sample thoroughly with the EDTA preservative contained in specimen vial 31.

After the specimen has been collected in vial 31, it is necessary to properly label tube 30 and to package the specimen for shipping to the clinical laboratory. After the user has slowly rotated tube 30 and vial 31 to mix the blood sample with the EDTA, the user then fills out the information requested on identification card 46 of kit 10. Information card 46 requests an authorization from the user to release the laboratory tests to the user's health care professional and to the user. Information card 46 further requests such information as name, social security number, address, city, state, zip code, physician name and physician address as well as other information. Once the user has completed information card 46, a self-adhesive bar code label 52a is removed from information card 46 and affixed to vial label 30. An identical bar code 52b is printed directly onto information card 46. The identical bar codes, one on information card 46, and one placed by the user on tube 30 provide correspondence between the user information on card 46 and the clinical laboratory test results obtained by analysis of the contents of vial 31. After the user has labeled tube 30 and completed information card 46, the information card and the specimen vial are shipped to the laboratory for testing.

To prepare sample vial 31 for shipment, the user opens vial bag 38 and inserts tube 30 and vial 31 into bag 38 (FIG. 5). Vial bag 38 is equipped with an adhesive seal which, when folded over on itself, completely seals the bag and prevents any escape of liquid material from the interior of the bag. To further prevent the leakage of liquid material from the bag should vial 31 become damaged during shipment, absorbent pad 54 is contained within bag 38 which will absorb the entire volume of fluid which is contained within vial 31. A type of liquid-tight bag which is suitable for the present application is marketed under the name VonSeal® by Vonco Products Lake Villa, Ill. (U.S. Pat. No. 4,510,621 and which is incorporated herein by reference).

After the user has sealed vial 31 into vial bag 38, the specimen can be packaged for shipping. The shipping apparatus of kit 10 is comprised of specimen case 14, case securing sleeve 50 and shipping box 12. Specimen case 14 has previously been preassembled at the factory to provide one L-shaped insulative holder 20 containing insulating pouch 23 in specimen case bottom 18 and a second holder and pouch in specimen case top 16. The insulative properties and the particular structural configuration of insulative holder 20 and insulating pouch 23 will be discussed hereinafter.

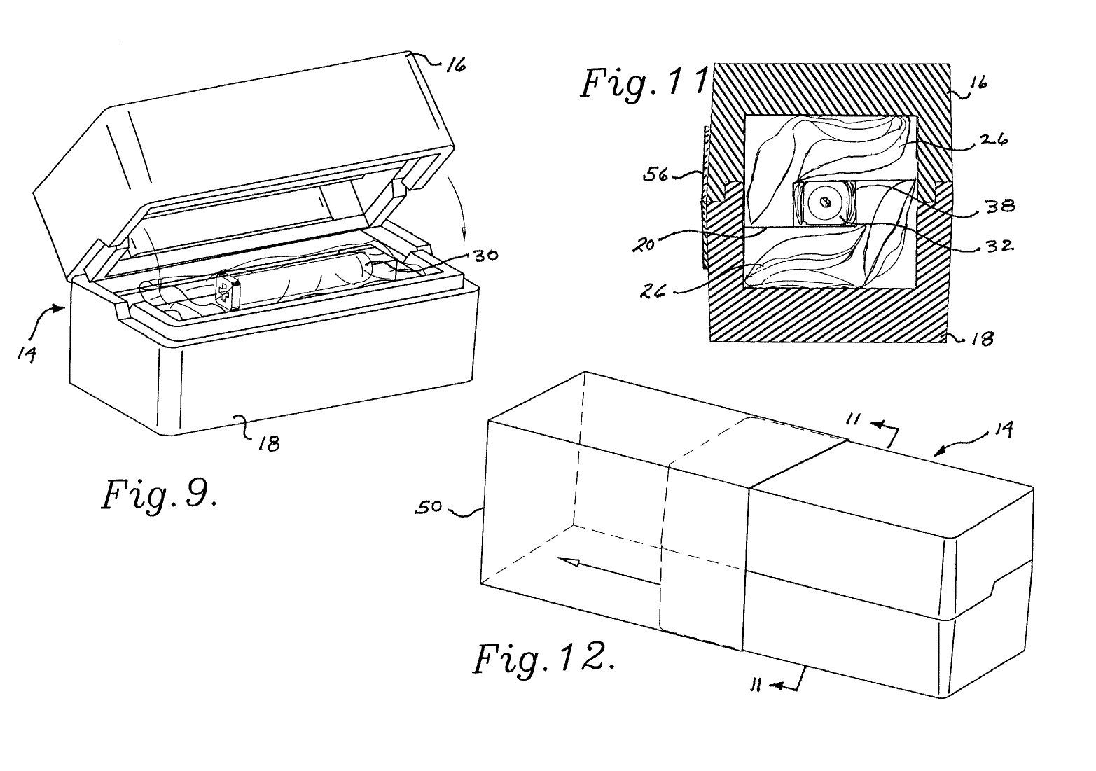

Referring now to FIG. 9, vial bag 38 containing tube 30 and vial 31 is placed within specimen case 14 and case top 16 is lowered into contact with case bottom 18. Once specimen case 14 is closed, vial bag 38 and vial 31 are held in secure fashion within case 14 as is shown in FIG. 11. In FIG. 11, it can be observed that when case 14 is closed, vial 31 is held in place at its top and bottom by holder body 1 of insulative holders 20 contained in the top 16 and bottom 18 of specimen case 14 and that the sides of vial 31 are held in place by holder arms 22 of L-shaped insulative holders 20. In this configuration, vial 31 is physically held in place on all sides by insulative holders 20 and vial 31 is insulated on all sides by insulative holders. It may be further observed in FIG. 11 that case top 16 is held into contact with case bottom 14 by case hinge 56. Case hinge 56 need be no more than a flexible adhesive plastic or paper strip which is placed along the juncture of top 16 and bottom 18 to provide a flexible, hinge connection. The purpose of the flexible hinge connection is to maintain the orientation between case top 16 and case bottom 18 and to maintain the orientation between insulative holders 20 contained therein. As the orientation between case top 16 and case bottom 18 is maintained through the opening and closing procedure, the likelihood of a user misaligning the case top and case bottom and disturbing the insulating properties of insulative holder 20 are minimized.

To maintain specimens in case 14 in a closed position during shipping and to provide additional insulation, case securing sleeve 50 is provided which holds specimen case 14 together during shipping. Referring now to FIG. 12, it is shown that once specimen case 14 is closed, it can be pushed into securing sleeve 50 in preparation for shipping. After the user has completed the fitting of specimen case 14 into securing sleeve 50, the sleeve and case 14 are placed into shipping box 12 (FIG. 1). Shipping box 12 is then sealed by the user and placed into mailing envelope 44 (FIG. 1) which is a pre-addressed, postage paid envelope for shipment of the package and insulated specimen back to the clinical laboratory for testing. After the specimen is received at the clinical laboratory, the securing sleeve, shipping box and specimen case are discarded and testing on the sample proceeds as usual.

Another inventive aspect of the present invention is a compact and lightweight construction of insulation material which is utilized in kit 10 to maintain the liquid biological sample at a temperature below 37 degrees centigrade and above approximately 5 degrees centigrade. The insulation design is based upon the concept that the use of multiple layers of discontinuous material will serve to disrupt even heat transfer within the package. In addition, the various material layers used in the insulation and will particularly interrupt even heat transfer at the junctions between the material layers. These multiple layers of insulating material present a discontinuous heat gradient which creates inefficiencies in the heat transfer between the interior of the package and the exterior of the package. In this manner, a liquid biological sample can be shipped from one location to another during all times of the year and be kept from overheating or freezing during the shipping process.

As previously discussed the present invention uses non-refrigerated or frozen materials to maintain proper specimen temperature. This eliminates the need for bulky cooling materials or cooling devices that require pre-cooling or pre-freezing for their operation. The prior art temperature-protective materials require the additional preparation steps of cooling or freezing of the pre-cooled or pre-frozen material by the user to effect their operation. The most widely used prior art shipping materials rely upon pre-cooled or pre-frozen polyethylene and glycol bricks which maintain the specimen at an acceptable temperature range. These polyethylene and glycol bricks are, generally, 2 inches by 4 inches by 4 inches. Such bricks must first be pre-cooled in a refrigerator or pre-frozen in a freezer by the user before they are placed into a protective package with specimen. This adds extra inconvenience for the user and requires the user to plan ahead for the specimen collection by remembering to place the polyethylene and glycol brick into the refrigerator or freezer the day before the specimen is to be collected and shipped.

The specimen collection kit of the present invention, by contrast, is small enough to fit in an ordinary mailbox and therefore is cost effective. This is a major advantage of the present invention in combination with the inventive insulation material over the prior art. The present invention provides a shipping package which is small enough to fit into a standard U.S. Postal Service approved mailbox. This allows the user of the present invention to simply place the sealed package containing the specimen into the standard U.S. Postal Service approved mailbox outside the users home and thereby avoid the need to take the package to the post office or the need to use another, less convenient, package shipper.

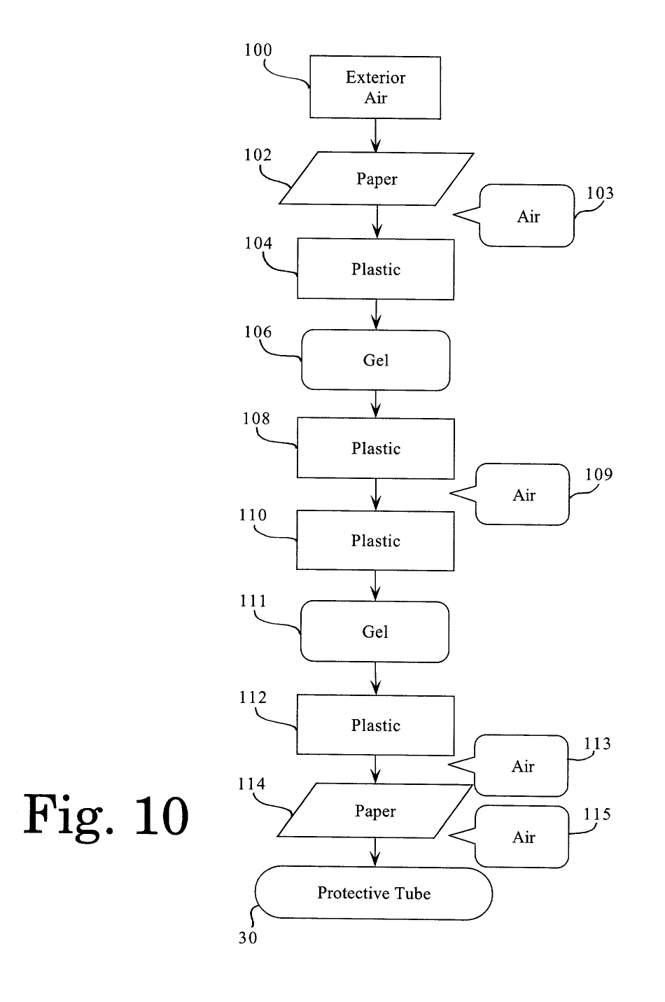

Referring now to FIG. 10, a schematic diagram of one embodiment of the layering used in the insulating packaging is shown. Exterior air 100 is separated from protective tube 30 by, in this embodiment, multiple individual material layers that provide multiple discontinuities in the transfer of heat between exterior air 100 and tube 30. Exterior air 100 first confronts paper 102 of insulative holder 20 (FIG. 8). The exterior air 100 must first equilibrate paper 102 to the temperature of exterior air 100 before the temperature differential existing between exterior air 100 and the next layer, plastic 104 of insulating pouch 23, can have an affect on plastic 104. In addition, the affect of the temperature differential must further overcome the transition between paper 102 and plastic 104 which contains an additional discontinuity in the air space which is present between at least some portions of paper 102 and plastic 104. This air space is present because there is not a continuous contact between the surface of paper 102 and plastic 104. In the insulative material of the present invention, the layering which creates heat transfer discontinuities continues between plastic 104 and gel 106 followed by the interface of gel 106 and plastic 108, and so on until the juncture between paper 114 of holder body 21 (FIG. 8) and tube 30 is reached.

As FIG. 10 is a cross-sectional representation of the layering which exists in holder body 21 of insulative holder 20 (FIG. 8), a plastic-plastic interface exists at the point at which one portion of insulating pouch 23 is folded over onto a center section of insulative pouch 23 (FIG. 8). At this plastic-plastic interface, the contact between plastic 108 and plastic 110 is not coextensive, but is interrupted by an air layer 109 which is captured between plastic 108 and plastic 110. This provides yet another disruption to heat transfer across the plastic-plastic junction in this segment of the insulative barrier of the present invention. Continuing through the various insulative areas toward tube 30, additional heat transfer discontinuities exist between plastic 110 and gel 111 followed by the junction between gel 111 and plastic 112 followed by the interface between plastic 112 and paper 114 and which is further interrupted by captured air 113 which is between plastic 112 and paper 114 of sleeve 20. Finally, the temperature change must cross the captured air barrier 115 which is between paper 114 of sleeve 20 and protective tube 30 before any change in temperature in the liquid blood sample within vial 31 can occur.

This extensive layering of different materials having different specific heat capacities causes a substantial slowing in the rate at which temperature change occurs between the exterior of the package and the interior of the package at which specimen vial 31 is located. The specific heat of a material is the number of joules required to raise the temperature of one gram of the material one degree Celsius (Q=mcD). As an object is heated or cooled, its internal energy changes, and thus its temperature changes. In the case of insulating against high temperatures, the amount of temperature change depends on the amount of heating (Q, measured in joules), the amount of material (m, measures in kilograms) and the type of material. The type of material is described by its specific heat capacity (c, usually measured in joules per gram per degrees Celsius).

Therefore, it can be seen that the insulation of the present invention relies upon creating substantial inefficiencies of heat exchange between the layers of different materials used in the insulation by selecting materials of differing specific heat capacities to be adjacent one another and to thereby create discontinuities in the efficient transfer of heat in either direction—either into or out of the center of the package where the specimen is located.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive insulated specimen sampling and shipping kit is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is as follows:

1. A blood specimen collection and shipping kit for obtaining a blood specimen from a user which does not contain a cooling device and which protects shipping of the obtained blood specimen to a clinical laboratory for testing comprising:
a blood specimen vial,
a lance for puncturing the finger of the user to cause blood flow from the finger,
an protective box to hold said vial during shipment,
an insulative barrier to enclose said vial to prevent said vial from being heated above 37° centigrade and cooled below approximately 5° centigrade,
a stand for holding said vial in an upright position during introduction of blood into said vial, and
an envelope for sending said impact protective container containing said vial to a clinical laboratory for testing.

2. The kit as claimed in claim 1 wherein said blood specimen vial has a volume marking thereon to indicate sample sufficiency.

3. The kit as claimed in claim 1 further comprising a funnel for insertion into said vial for directing blood flow into said vial.

4. The kit as claimed in claim 1 further comprising a capilary tube for transferring blood from the finger of the user and into said vial.

5. The kit as claimed in claim 1 further comprising an impact resistant specimen case to hold said vial.

6. The kit as claimed in claim 1 further comprising a insulative holder to contain said insulative barrier.

7. The kit as claimed in claim 1 further comprising a outer protective tube surrounding said vial.

8. The kit as claimed in claim 1 further comprising an alcohol pad for cleaning the finger of the user.

9. The kit as claimed in claim 1 further comprising a vial bag.

10. The kit as claimed in claim 9 further comprising an absorbent pad in said vial bag.

11. The kit as claimed in claim 1 further comprising a bandage.

12. The kit as claimed in claim 1 further comprising a information card.

13. The kit as claimed in claim 1 further comprising a waste bag.

14. An insulating composition for maintaining a shipment of a biological specimen within a temperature range compatible with biological sample clinical testing comprising a plurality of layers of different materials placed adjacent one another to present a junction, said junction of at least two of said layers providing a disruption of the transfer of heat between said at least two layers.

15. The composition of claim 14 wherein said disruption of the transfer of heat at said junction is caused by each layer of said two layers having a different specific heat capacity.

16. An insulating barrier for surrounding a biological sample during shipment to maintain the sample within a temperature range compatible with biological sample clinical testing comprising:
a flexible plastic cover comprised of a front layer and a rear layer, said cover having a plurality of cells formed between said layers by joining together said front and rear layers to form a sealed perimeter around each of said plurality of cells, and
a liquid captured within each of said cells, said liquid remaining in a fluid state in a temperature range between approximately 0 degrees centigrade and approximately 40 degrees centigrade.

17. The apparatus as claimed in claim 16 further comprising a paper sleeve adapted to receive said barrier therein.

18. The apparatus as claimed in claim 17 wherein said barrier is folded-over on itself prior to insertion into said sleeve.

19. A specimen collection and shipping kit for obtaining a specimen of a biological fluid from a user which does not contain a cooling device and which provides protected shipping of the obtained specimen to a clinical laboratory for testing comprising:
a specimen vial,
an protective box to hold said vial during shipment,
an insulative barrier to for insertion into said protective box to prevent said vial from being heated above 37° C. and cooled below approximately 5° C., and
an envelope for sending said impact protective container containing said vial to a clinical laboratory for testing.
